(19) United States
(12) Patent Application Publication
(10) Pub. No.: US 2014/0300835 A1
(43) Pub. Date: Oct. 9, 2014

(54) TOUCH PANEL

(71) Applicant: WINTEK CORPORATION, Taichung City (TW)

(72) Inventors: Kuan-Yu Chu, Taichung City (TW); Yu-Ching Wang, Taichung City (TW); Chin-Pei Hwang, Taichung City (TW); Ming-Wu Chen, Nantou County (TW); Chin-Yi Hsu, Taichung City (TW); Chun-Cheng Huang, Yunlin County (TW); Chen-Fu Huang, Taichung City (TW); Yi-Chun Lin, Changhua County (TW); Ming-Kung Wu, Taichung City (TW); Ta-Wei Yeh, Taichung City (TW)

(73) Assignee: WINTEK CORPORATION, Taichung City (TW)

(21) Appl. No.: 14/243,901

(22) Filed: Apr. 3, 2014

(30) Foreign Application Priority Data
Apr. 3, 2013 (TW) 102112192

(51) Int. Cl. G06F 1/16; G06F 3/047

(52) U.S. Cl. CPC G06F 1/1637; G06F 3/047
USPC 349/12; 361/679.26

(57) ABSTRACT

A touch panel, having a light transmission touch sensing region and a peripheral region adjacent to at least one side of the light transmission touch sensing region, includes an inner frame and a decoration frame disposed in the peripheral region. The peripheral region has an inner edge and an outer edge, wherein the inner edge is closer to the light transmission touch sensing region than the outer edge. The inner sidewall of the inner frame is disposed along the inner edge of the peripheral region. The decoration frame includes at least one decoration layer. The pattern of the decoration layer does not exceed the inner edge of the peripheral region.

### BACKGROUND OF THE INVENTION

1. Field of the Invention

The present invention relates to a touch panel, and more particularly, to a touch panel including an inner frame disposed in its peripheral region.

2. Description of the Prior Art

Since touch panels provide human-machine interaction, they have been widely applied to smart phones, global positioning navigator systems (GPS navigator system), tablet personal computers (tablet PC), personal digital assistants (PDA), laptop personal computers (laptop PC), and other electronic devices.

Please refer to FIG. 1 and FIG. 2. FIG. 1 is a schematic diagram of the top view of a traditional touch panel. FIG. 2 is a schematic diagram of the cross-sectional view of the partial region P shown in FIG. 1. As shown in FIG. 1, the color decoration layer 12 on the touch device 10 sometimes needs thicker ink layers to provide sufficient coverage for the wires and electronic elements behind. As the example shown in FIG. 2, the color decoration layer 12 includes three or even more ink layers 18, 20, 22 disposed on the surface of the transparent substrate 16 in order. In the subsequent fabrication processes of transparent electrode or wires, for example, when the transparent electrode 14 extends onto the color decoration layer 12, problems such as breakage or poor reliability may easily occur due to the height differences caused by the ink layers 18, 20, 22 of the color decoration layer 12 being too thick. In the prior art, the ink layers 18, 20, 22 usually are formed by screen printing. In order to make the transparent electrode 14 have better climbing effect on the color decoration layer 12, the ink layers 18, 20, 22 must be designed with different pattern ranges to decrease the slope of the edges, but this method will increase the costs of screens. Moreover, printing tolerance and other issues will cause the position offset of ink layers 18, 20, 22. All the above conditions may result in uneven edges of the color decoration layer 12, such as jagged edges. Also, since the edges of the color decoration layer 12 are usually thinner than its central part, they cannot provide effective coverage. If a dark shielding layer is further disposed on the color decoration layer 12, the color of the dark shielding layer may vaguely show up at the edge part, which causes that the appearance color of the color decoration layer 12 appears black and gray at the edge part and the aesthetic effect of the display panel is greatly reduced.

### SUMMARY OF THE INVENTION

One of the objects of the present invention is to provide a touch panel, including an inner frame disposed along the inner edge of the peripheral region of the touch panel to improve the appearance of the touch panel, as well as the yield of the connecting part, and to prevent the problems of breakages of electrodes or wires.

To achieve the above objective, the present invention discloses a touch panel having a light transmission touch sensing region and a peripheral region adjacent to at least one side of the light transmission touch sensing region. The peripheral region has an inner edge and an outer edge, wherein the inner edge is closer to the light transmission touch sensing region than the outer edge. The touch panel of the present invention includes an inner frame and a decoration frame. The inner frame is disposed in the peripheral region and includes at least one inner frame layer. The inner sidewall of the inner frame is disposed along the inner edge of the peripheral region. The decoration frame is disposed in the peripheral region and includes at least one decoration layer. The pattern range of the decoration layer does not exceed the inner edge of the peripheral region.

To achieve the above objective, the present invention further discloses a touch panel having a light transmission touch sensing region and a peripheral region adjacent to at least one side of the light transmission touch sensing region. The touch panel of the present invention includes a decoration frame and an inner frame. The decoration frame is disposed in the peripheral region and it includes an inner sidewall and an outer sidewall that opposite to each other. The inner sidewall is adjacent to the light transmission touch sensing region. The inner frame is disposed in the peripheral region to cover at least one portion of the inner sidewall of the decoration frame and exposes the outer sidewall of the decoration frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the top view of a touch panel according to the prior art.

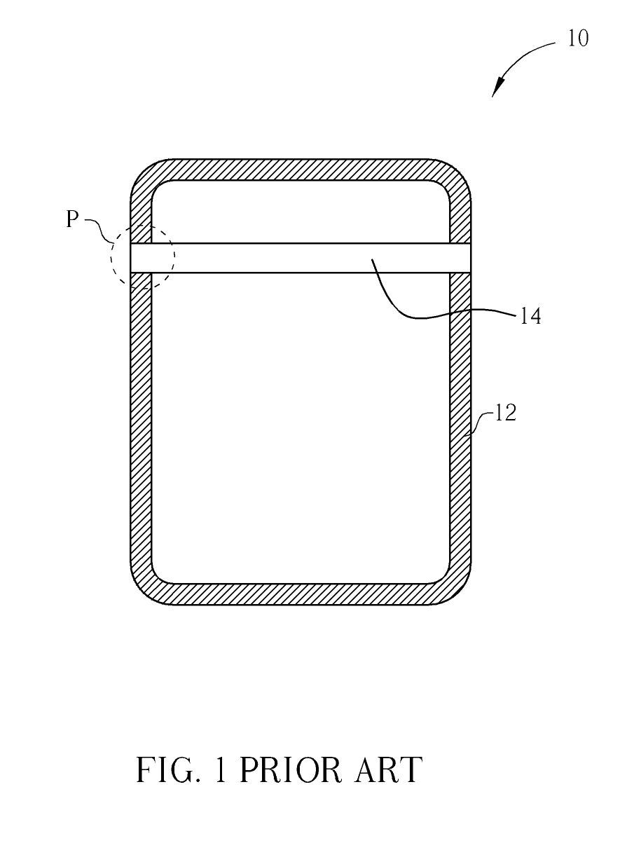

FIG. 2 is a schematic diagram of the partial cross-sectional view of region P shown in FIG. 1.

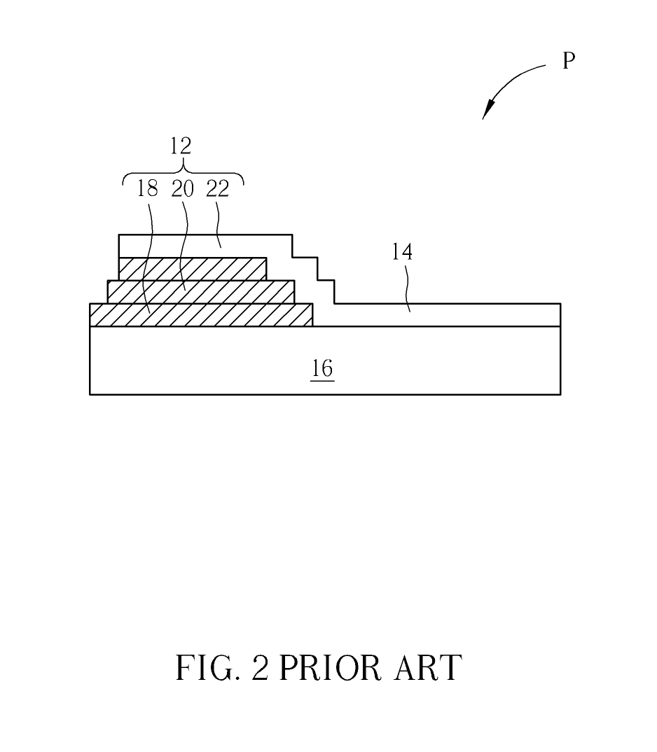

FIG. 3 is a schematic diagram of the partial sectional view of a touch panel according to the first preferred embodiment of the present invention.

FIG. 4 is a schematic diagram of the top view of the touch panel shown in FIG. 3.

FIG. 5 is a schematic diagram of the top view of a touch panel according to the second preferred embodiment of the present invention.

FIG. 6 is a schematic diagram of the top view of a touch panel according to the third preferred embodiment of the present invention.

FIG. 7 is a schematic diagram of a touch panel according to the fourth preferred embodiment of the present invention.

FIG. 8 is a schematic diagram of a touch panel according to the fifth preferred embodiment of the present invention.

FIG. 9 is a schematic diagram of a touch panel according to the sixth preferred embodiment of the present invention.

FIG. 10 is a schematic diagram of a touch panel according to the seventh preferred embodiment of the present invention.

FIG. 11 is a schematic diagram of a touch panel according to the eighth preferred embodiment of the present invention.

FIG. 12 is a schematic diagram of the top view of a touch panel according to the ninth preferred embodiment of the present invention.

FIG. 13 is a schematic diagram of the partial cross-sectional view of the touch panel shown in FIG. 12.

FIG. 14 is a schematic diagram of the exterior of a touch panel according to the tenth preferred embodiment of the present invention.

### DETAILED DESCRIPTION

To provide a better understanding of the present invention to the skilled users in the technology of the present invention, preferred embodiments will be detailed as follows. The preferred embodiments of the present invention are illustrated in the accompanying drawings with numbered elements to elaborate on the contents and effects to be achieved.

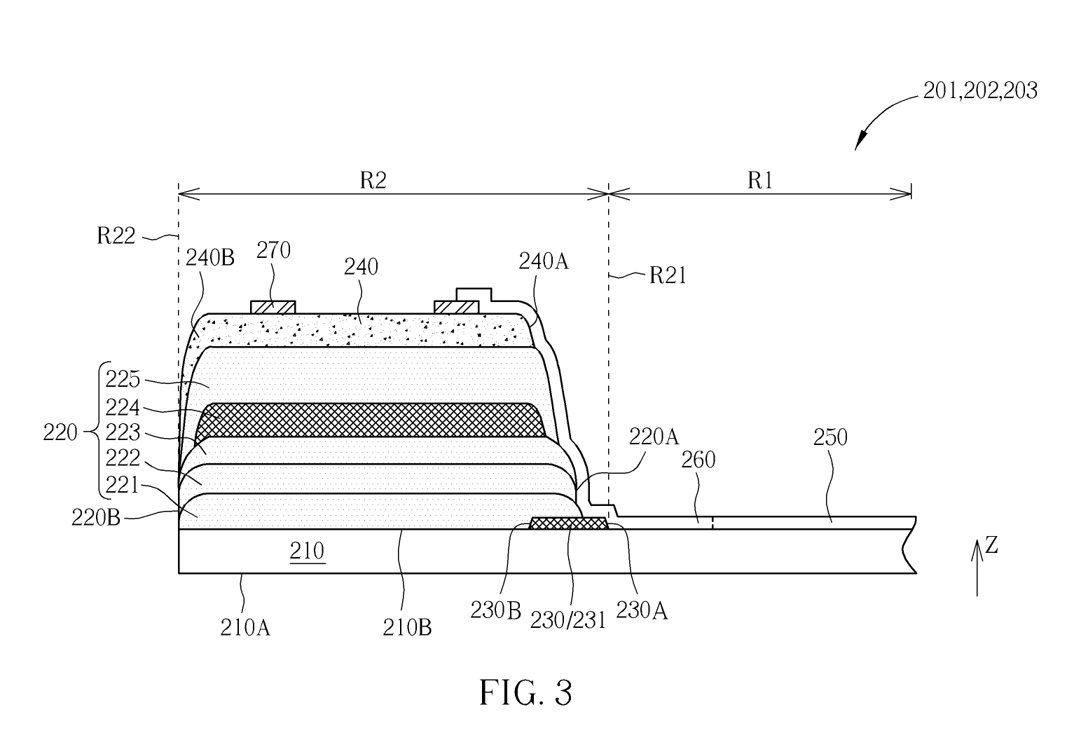

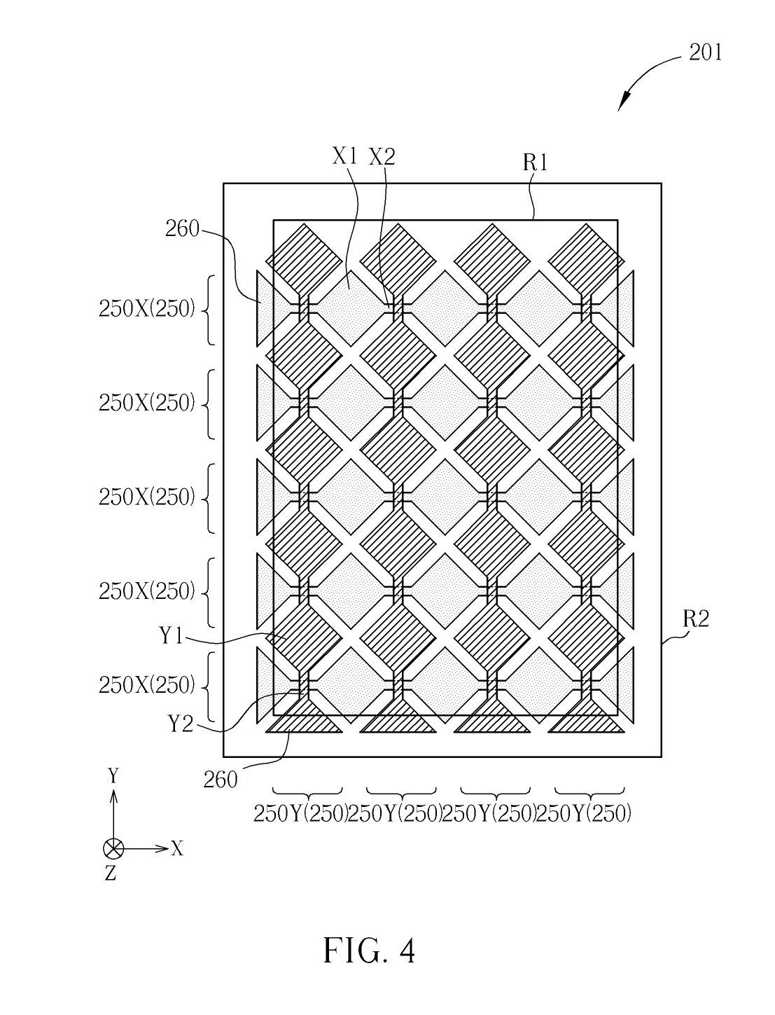

Please refer to FIG. 3 and FIG. 4. FIG. 3 is a schematic diagram of a sectional view of a touch panel according to the first preferred embodiment of the present invention. FIG. 4 is a schematic diagram of the top view of the touch panel according to the first preferred embodiment of the present invention. To simplify the description and the drawings, all the figures of the present invention are only schematic in order to explain the present invention more easily. The detail and actual size proportion of this embodiment may be adjusted according to the design requirements. As shown in FIG. 3 and FIG. 4, this embodiment provides a touch panel 201 including a light transmission touch sensing region R1 and a peripheral region R2. The peripheral region R2 is adjacent to at least one side of the light transmission touch sensing region R1. The peripheral region R2 of this embodiment surrounds the areas around the light transmission touch sensing region R1, but not limited thereto. The peripheral region R2 may be adjacent to only a portion of the edges of the light transmission touch sensing region R1 as needed, for example, adjacent to only the top and bottom edges. Also, the peripheral region R2 may optionally include touch sensing elements (not shown in the figure), but still be classified as the peripheral region R2, which is explained here first.

The peripheral region R2 includes an inner edge R21 and an outer edge R22. The inner edge R21 is closer to the light transmission touch sensing region R1 than the outer edge R22. In this embodiment, the inner edge R21 of the peripheral region R2 is adjacent to the light transmission touch sensing region R1 and connected to the light transmission touch sensing region R1. The touch panel 201 includes a substrate 210, a decoration frame 220, and an inner frame 230. According to this embodiment, the substrate 210 is a cover plate with a touch sensing function. It has a touch surface 210A and an inner surface 210B opposite to the touch surface 210A. The inner fame 230 and the decoration frame 220 are disposed on the inner surface 210B of the substrate 210 in the peripheral region R2. Other layers (not shown in the figures) may be disposed between both the inner frame 230 and the decoration frame 220 and the inner surface 210B of the substrate 210, such as optical layers of silicon oxide, silicon nitride, or composite layers thereof, but is not limited thereto, for example, titanium oxide or organic layer such as acrylic resin, epoxy resin, phenolic resin, siloxane or polyimide may also be applied. The inner frame 230 includes an inner sidewall 230A and an outer sidewall 230B that are opposite to each other, and also includes at least one dark inner frame layer 231. The inner sidewall 230A is substantially disposed along the inner edge R21. Therefore, the shape of the inner frame 230 in this embodiment is a closed ring, but the present invention is not limited thereto. For example, in other embodiment, when the peripheral region is only disposed near the top and the bottom sides of the light transmission touch sensing region, the inner frame also corresponds to the disposition of the peripheral region and therefore is only disposed near the top and bottom edges of the light transmission touch sensing region. Furthermore, the dimension of the pattern of the inner frame 230 is smaller than the area of the peripheral region R2. For example, the inner frame 230 in FIG. 3 is only disposed around the inner edge of the peripheral region R2, which means the inner frame 230 is disposed in the portion of the peripheral region R2 adjacent to the light transmission touch sensing region R1. The decoration frame 220 includes an inner sidewall 220A and an outer sidewall 220B that are opposite to each other. Wherein, the inner sidewall 220A is adjacent to the light transmission touch sensing region R1.

The decoration frame 220 includes at least one decoration layer disposed in the peripheral region R2. For example, the decoration frame 220 in this embodiment may optionally include three layers of non-black decoration layers 221, 222, 223 disposed on the inner surface 210B in order to cover a portion of the inner frame 230, but not limited thereto. The decoration layer can be any color in other embodiments. In addition, the decoration frame 220 or at least one of the decoration layers 221, 222, 223 do not necessarily cover a portion of the inner frame 230. It can be closely adjacent to and in contact with the outer sidewall 230B of the inner frame 230, or be separated by a gap from the outer sidewall 230B of the inner frame 230. Moreover, although the figure shows that the decoration frame 220 or the decoration layer 221 directly covers a portion of the inner frame 230, the present invention is not limited thereto and other dielectric layers may exist between the decoration frame 220 or the decoration layer 221 and the inner frame 230. It is also noteworthy that the outer sidewall 230B of the inner frame 230 in other embodiment may cover on top of one of the decoration layers 221, 222, 223. Although the decoration layers 221, 222, 223 cover a portion of the inner frame 230, the ranges of the patterns of the decoration layers 221, 222, 223 do not exceed the inner edge R21 of the peripheral region R2, which means that the inner sidewall 220A of the decoration frame 220 adjacent to the light transmission touch sensing region R1 does not exceed the inner sidewall 230A of the inner frame 230, or is not disposed inside the light transmission touch sensing region R1. Furthermore, the pattern ranges of the decoration layers 221, 222, 223 are preferably larger than the pattern ranges of the inner frame 230. For example, the decoration layers 221, 222, 223 partially covers the surface of the inner frame 230 in the vertical projection direction Z and the outer sidewall 220B of the decoration frame 220 exceeds the outer sidewall 230B of the inner frame 230, wherein a large portion or the majority of the decoration layer 221 is directly disposed on the inner surface 210B of the substrate 210 in the peripheral region R2. As a result, according to the present invention, the inner frame 230 covers at least one portion of the inner sidewall 220A of the decoration frame 220. Preferably, the inner frame 230 in this embodiment covers the entire inner sidewall 220A of the decoration frame 220. Furthermore, the outer sidewall 230B of the inner frame 230 may also extend outwards to match or exceed the outer sidewall 220B of the decoration frame 220.

In addition, the decoration frame 220 in this embodiment may optionally include a dark decoration layer 224 and a top decoration layer 225 covering on the decoration layer 223 in order. The pattern range of the dark decoration layer 224 may be slightly smaller than the pattern ranges of the decoration layers 221, 222, 223 for improving the light shading effect of the decoration frame 220. The pattern range of the top decoration layer 225 may be about the same as or slightly smaller than the pattern ranges of the decoration layers 221, 222, 223 and partially overlap with the inner frame 230 in the vertical projection direction Z. At least one of the outer sidewalls of the decoration layers 221, 222, 223 and the top decoration layer 225 is disposed along the outer edge R22 of the peripheral region R2. As shown in FIG. 3, in this embodiment, all the outer sidewalls of the decoration layers 221, 222, 223 and the top decoration layer 225 are disposed along the outer edge R22. Therefore, in the preferable embodiment, the outer sidewall 220B of the decoration frame 220 is disposed along the outer edge R22. In other words, the outer sidewall 220B of the decoration frame 220 exceeds the outer sidewall 230B of the inner frame 230 so that the inner frame 230 reveals the outer sidewall 220B of the decoration frame 220.

In this embodiment, the optical density (OD) of the inner frame layer 231 included in the inner frame 230 is preferably greater than anyone of the decoration layers 221, 222, 223 and the top decoration layer 225. In a preferred embodiment, the OD of the inner frame layer 231 is greater than the individual OD of each of the decoration layers 221, 222, 223 and the top decoration layer 225 and the overall OD of the above-mentioned four layers. The color of the inner frame 230 is darker such as black and gray but is not limited thereto. It can also be other colors to enrich the color collocation, or the inner frame 230 may have the same color as the decoration layers 221, 222, 223 in order to achieve the unity of appearance. Also, the material of the inner frame layer 231 may be dark photoresist, such as black photoresist and gray photoresist, dark ink, such as black ink, gray ink, or black matrix (BM) that commonly applied to display panels and touch panels, but not limited thereto. Other materials and the color variation of the inner frame 230 as mentioned above may also be applied to the present invention. Depending on design requirement, the decoration layers 221, 222, 223 and the top decoration layer 225 may have the same color, such as white or other colors with OD lower than the black decoration layer. The overall OD of the decoration frame 220 may be increased according to the stacking way of the above-mentioned decoration layers, but the present invention is not limited to thereto and the desired color effect may be achieved by using the decoration layers and top decoration layer with different colors through blending the colors. The decoration layers 221, 222, 223 and the top decoration layer 225 may individually include color ink layer, color photoresist layer, or metal layer. The desired color and metallic appearance may be formed by the design of the stacking ways. More specifically, the decoration layers 221, 222, 223 may have the same materials. For example, they may be three color ink layers, three color photoresist layers, or three metal layers. In another aspect, the decoration layers 221, 222, 223 may be the combination of layers with materials not exactly the same, such as, but not limited to, two color ink layers with one metal layer or two color photoresist layers with one metal layer. Besides, the material of the top decoration layer 225 may be different from or the same as the decoration layers 221, 222, 223. Moreover, the OD of the dark decoration layer 224 is greater than the ODs of the decoration layers 221, 222, 223 and the top decoration layer 225. The material of the dark decoration layer 224 may be the same as or different from that of the inner frame 230, and its color for example may be, but not limited to, black.

In a preferable embodiment, the inner frame 230 is formed by lithography process. Therefore, the inner frame 230 may have more accurate patterns and more precise dimension. For example, the inner frame 230 may be substantially disposed along the inner edge R21 and include a smooth inner sidewall 230A. On the other hand, the decoration layers 221, 222, 223, the dark decoration layer 224, and the top decoration layer 225 may be formed on the substrate 210 by the printing process, the lithography process, or other suitable processes. Since the inner sidewall 220A of the decoration frame 220 does not exceed the inner sidewall 230A of the inner frame 230, the inner frame 230 provides effective coverage and shield functionality at the inner edge R21 of the peripheral region R2 to cover a portion or all of the inner sidewall 220A of the decoration frame 220. As a result, the requirement of position accuracy of the decoration layers 221, 222, 223, the dark decoration layer 224, and the top decoration layer 225 in the subsequent fabrication process may be lowered. Even though there are offsets or misalignments to make the edges of the layers uneven, they will be covered by the inner frame 230. The inner side of the decoration frame 220 can still appear even and have a good-looking on the touch surface 210A.

Furthermore, the touch panel 201 may further include a light-shielding layer 240, at least one touch sensing element 250, at least one connecting part 260, and at least one wire 270. The light-shielding layer 240 is disposed on the decoration frame 220 and may be, but not limited to, a black, gray or other dark color ink layer or a metal layer for example. Any layer with the function of blocking light may be used as the light-shielding layer 240. The wire 270 is disposed on the decoration frame 220 in the peripheral region R2. More specifically, the wire 270 is disposed on the light-shielding layer 240 in the peripheral region R2, and the light-shielding layer 240 is used for covering or hiding the wire 270 in the peripheral region R2, but not limited thereto. Preferably, the inner sidewall 240A of the light-shielding layer 240 partially overlaps the inner frame 230 in the vertical projection direction Z. Its outer sidewall 240B is preferably disposed along the outer edge R22 of the peripheral region R2. Besides, the light-shielding layer 240 does not cover the inner sidewall 220A of the decoration frame 220. It is noteworthy that the overall pattern range of both the inner frame 230 and the light-shielding layer 240 in this embodiment is substantially the same as the area of the peripheral region R2 to achieve the purpose of shielding the other elements on the inner surface 210B of the substrate 210 in order to improve the appearance of the touch panel 201.

It is noteworthy that the same or similar color or material as the decoration layers 221, 222, 223 or the top decoration layer 225 may be used for forming the light-shielding layer 240 since it extends to one sidewall of the decoration frame 220 in consideration with the visual effect of the sidewall in this embodiment. However, if the coverage effect is considered, the material with better light blocking quality may be utilized to form the light-shielding layer 240, such as black, gray or other dark photoresist or ink material. The touch sensing element 250 is disposed on the inner surface 210B of the substrate 210 in the light transmission touch sensing region R1. The connecting part 260 is disposed on the inner surface 210B of the substrate 210, extending along the inner sidewall 220A of the decoration frame 220 so as to electrically connect the touch sensing element 250 with the wire 270. In this embodiment, the substrate 210 preferably includes a rigid substrate such as cover glass, a flexible glass, a rigid plastic substrate, a thin film substrate, or a substrate formed by other suitable materials. The rigid substrate can be strengthened by chemical or physical treatment for enhancing its strength against outside force of impact, bending, and scratch. In other embodiment, the substrate 210 may not have the touch sensing function, and may be any type of the substrate to be used only for carrying the inner frame 230 and the decoration frame 220, while the touch sensing element 250 may be disposed on another substrate (not shown in the figure) in the touch panel 201. The substrate carrying the touch sensing element can be a glass substrate, a film substrate, a color filter substrate of a LCD or an encapsulation plate of an OLED display. The touch sensing element in all embodiments of this invention can use conductive material such as ITO, IZO, silver nanowire, carbon nanotube, grapheme, silicone, or metal. Further, the touch sensing element can be patterned like mesh shape and the line width of mesh is in the range of 0.5 μM to 20 μm. For example, the touch sensing element comprise metal mesh structure and the line width of metal mesh is in the range of 0.5 μm to 8 μm. The touch sensing element with metal mesh structure has light transmission rate higher than 85%. The wire 270 and the connecting part 260 are preferred to include transparent conductive materials such as indium tin oxide (ITO), indium zinc oxide (IZO), and aluminum zinc oxide (AZO) or other suitable non-transparent conductive materials such as silver, aluminum, copper, magnesium, molybdenum, the composite layers of the above materials or the alloy of the above materials, but not limited thereto. The touch sensing element 250 may be electrically connected to the wire 270 disposed in the peripheral region R2 by the connecting part 260, and furthermore be electrically connected to other elements (not shown in the figure) such as controlling integrated circuit by the wire 270 to drive the touch sensing element 250. Moreover, it should be noted that the connecting part 260 may be considered as a part of the touch sensing element 250. In addition, although the stacking thickness of all the layers of the decoration frame 220 is thick, the height drop between the inner surface 210B of the substrate 210 and the decoration frame 220 may be reduced because the inner frame 230 with thinner thickness is disposed around the inner edge R21 of the peripheral region R2, so that the breakage and other defects of the connecting part 260 caused by severe drop will be avoided. When the drop induced by the decoration frame 220 for example is even greater, more than two inner frame layers of the inner frame may be disposed as needed, while a step structure is preferably provided between the two adjacent inner frame layers for decreasing the probability of breakage. Therefore, in this embodiment, when the decoration layers 221, 222, 223 and even the top decoration layer 225 are fabricated with the screen printing process, the screen plate can be shared to fabricate the above-mentioned layers with substantially the same pattern ranges or sizes because the problem of the fabrication yield of the connecting part 260 easily affected by the severe drop between the inner surface 210B and the surface of the decoration frame 220 is improved by the disposition of the inner frame 230. As a result, it saves the costs of screen plates and designs. The description that the pattern ranges of the decoration layers 221, 222, 223 are substantially the same means that the differences among the three are not exceeding 10% of each pattern range.

As shown in FIG. 4, the touch sensing element 250 in this embodiment preferably include a plurality of first axial electrodes 250X and a plurality of second axial electrodes 250Y that are disposed crossly and isolated from each other, through the way of disposing an entire plane of an insulating layer or disposing island-shaped insulating layers only at the intersections. Each first axial electrode 250X extends along a first direction X. Each second axial electrode 250Y extends along a second direction Y. Preferably, the first direction X is perpendicular to the second direction Y, but not limited thereto. Each first axial electrode 250X includes a plurality of first inducing electrodes X1 and a plurality of first connecting wires X2 disposed in the light transmission touch sensing region R1. Each second axial electrode 250Y includes a plurality of second inducing electrode Y1 and a plurality of second connecting wires Y2 disposed in the light transmission touch sensing region R1. The first inducing electrode X1 and the second inducing electrode Y1 are preferred to be evenly arranged in the light transmission touch sensing region R1 to perform touch-sensing detection. The first connecting wires X2 and the second connecting wires Y2 are used for connecting the first inducing electrodes X1 of the same first axial electrode 250X and connecting the second inducing electrodes Y1 of the same second axial electrode 250Y respectively. In this embodiment, the connecting part 260 is a portion of the first axial electrode 250X and the second axial electrode 250Y, and it extends to the peripheral region R2 to be electrically connected with the wires (not shown in FIG. 4).

The different implementation states of the touch panel of the present invention will be explained below. To simplify the explanation, the following description will focus mainly on the details of the differences among the embodiments, rather than repeating their similarities. Besides, the similar components in each embodiment of the present invention will be labeled with the same numerals in order to facilitate comparisons among embodiments.

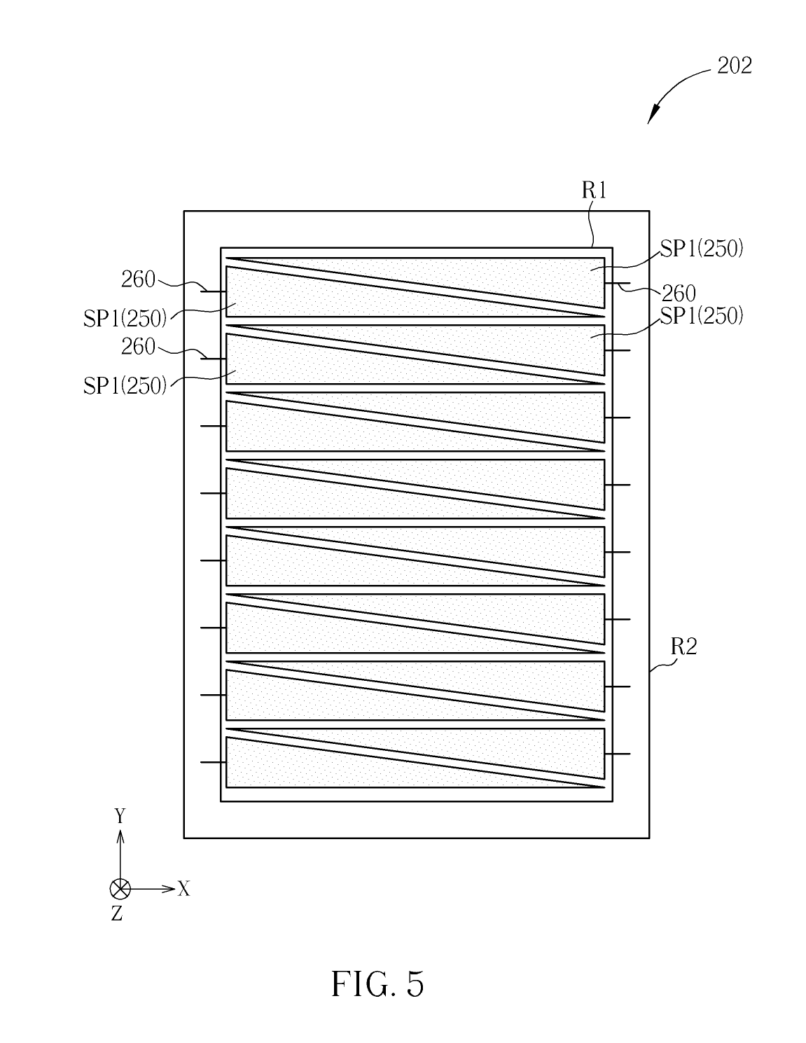

Please refer to FIG. 3 and FIG. 5. FIG. 5 is a schematic diagram of the top view of a touch panel according to the second preferred embodiment of the present invention. As shown in FIG. 5 and FIG. 3, the second preferred embodiment of the present invention provides a touch panel 202. It is different from the touch panel 201 in the first preferred embodiment mentioned above in that the touch sensing element 250 in the touch panel 202 preferably includes a plurality of inducing electrodes SP1 disposed separately from each other in the light transmission touch sensing region R1 to perform touch-sensing detection. The connecting parts 260 of the touch panel 201 connect with the inducing electrodes SP1 and extend to the peripheral region R2 to electrically connect with the wire 270. Except for the inducing electrodes SP1, the characteristics, positions, and materials of all the components of the touch panel 202 in this embodiment are similar to those in the first embodiment. Therefore they will not be repeated herein. It is noteworthy that each inducing electrode SP1 in this embodiment is preferred to be a triangle electrode. However, the present invention is not limited to the shapes of the inducing electrodes SP1, and the inducing electrodes SP1 with different shapes may be uniformly arranged in the light transmission touch sensing region R1 as needed to achieve the desired effect of touch-sensing detection. In addition, the inducing electrodes SP1, for example, may include indium tin oxide and other transparent conductive materials or metal mesh.

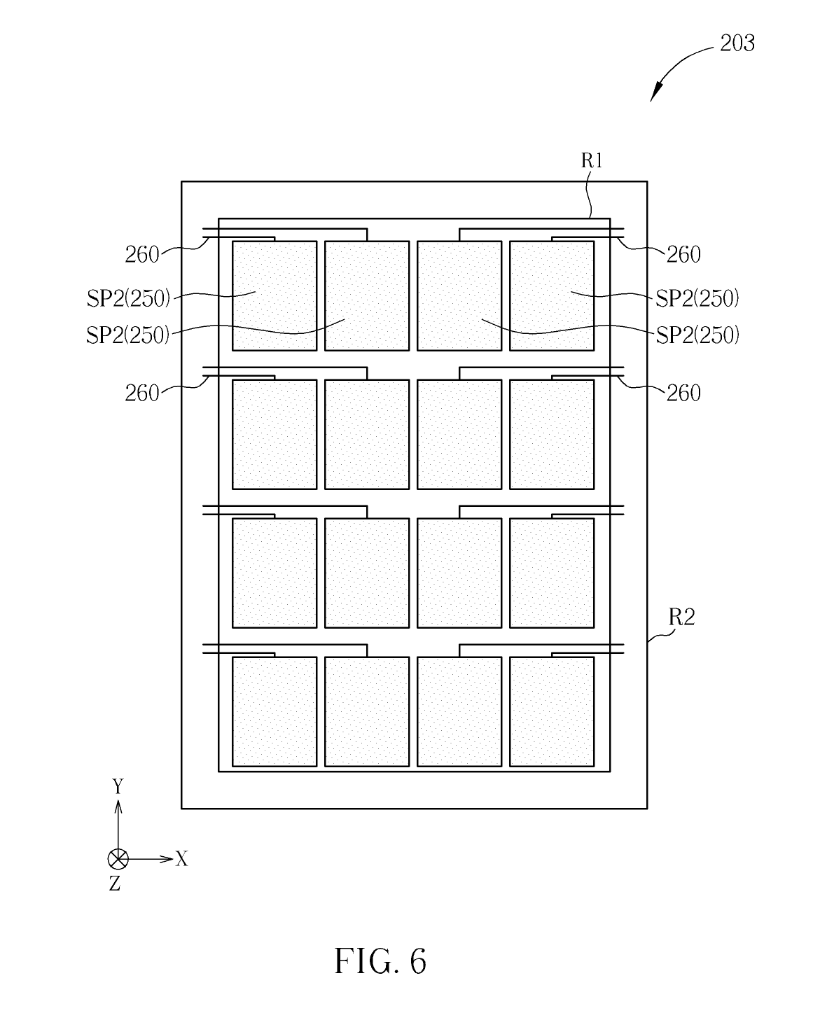

Please refer to FIG. 3 and FIG. 6. FIG. 6 is a schematic diagram of the top view of a touch panel according to the third preferred embodiment of the present invention. The third preferred embodiment of the present invention provides a touch panel 203. Preferably, the touch sensing element 250 in the touch panel 203 includes a plurality of inducing electrodes SP2 disposed separately from each other in the light transmission touch sensing region R1 to perform touch-sensing detection. Each inducing electrode SP2 in this embodiment is, but not limited to, a rectangular electrode. However, in different variant embodiments, the inducing electrodes SP2 with different regular or irregular shapes may be uniformly arranged in the light transmission touch sensing region R1 as needed, such as a plurality of strip electrodes collocated with a plurality of pad electrodes disposed between two adjacent strip electrodes so as to obtain the desired effect of touch-sensing detection.

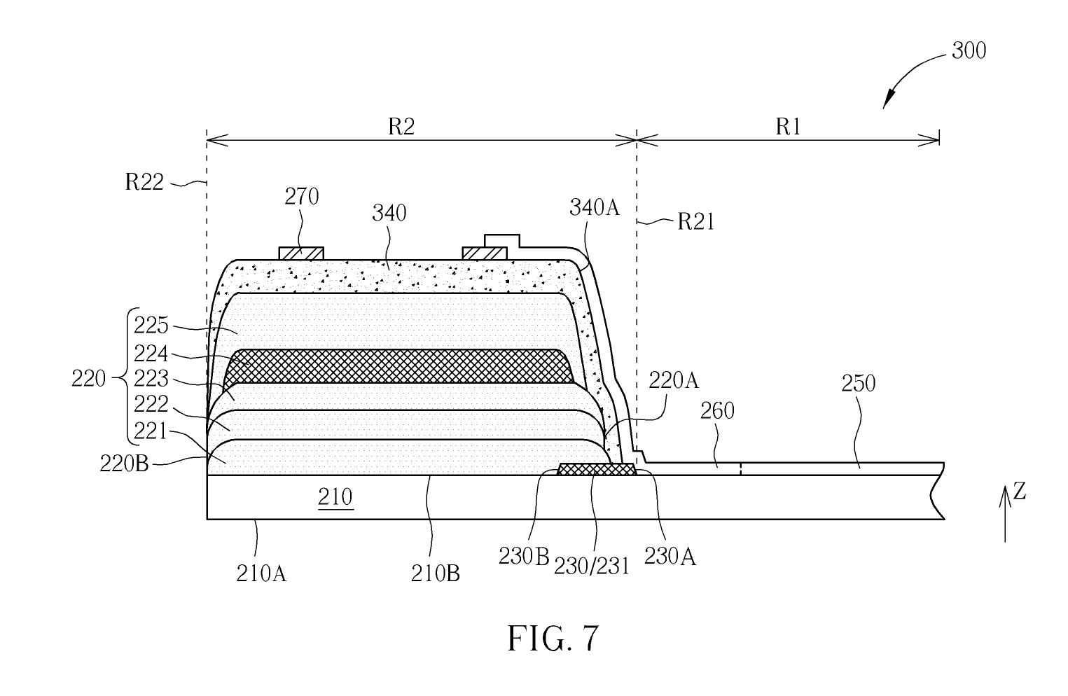

Please refer to FIG. 7. FIG. 7 is a schematic diagram of a touch panel according to the fourth embodiment of the present invention. As shown in FIG. 7, the fourth embodiment of the present invention provides a touch panel 300. Different from the touch panel 201 in the first embodiment, the inner sidewall 340A of the light-shielding layer 340 of the touch panel 300 covers the inner sidewall 220A of the decoration frame 220 and partially covers the inner frame 230 and directly contacts the top surface of the inner frame 230. Therefore, the inner sidewall 340A of the light-shielding layer 340 may fill the junctions between two adjacent layers of the decoration layers 221, 222, 223 and the top decoration layer 225. In addition, the light-shielding layer 340 partially overlaps the inner frame 230 in the vertical projection direction Z. In the preferred embodiment, the inner sidewall 340A of the light-shielding layer 340 does not reach the inner edge R21 of the peripheral region R2, which means that the inner sidewall 340A of the light-shielding layer 340 does not overlap the inner sidewall 230A of the inner frame 230. Accordingly, the topography and profile of the stacked layers that the connecting part 260 climbs are more gentle, which further increases the reliability of the connecting part 260. Except for the light-shielding layer 340, the characteristics, positions, and materials of all components of the touch panel 300 in this embodiment are similar to those in the first preferred embodiment mentioned above and therefore are not repeated herein.

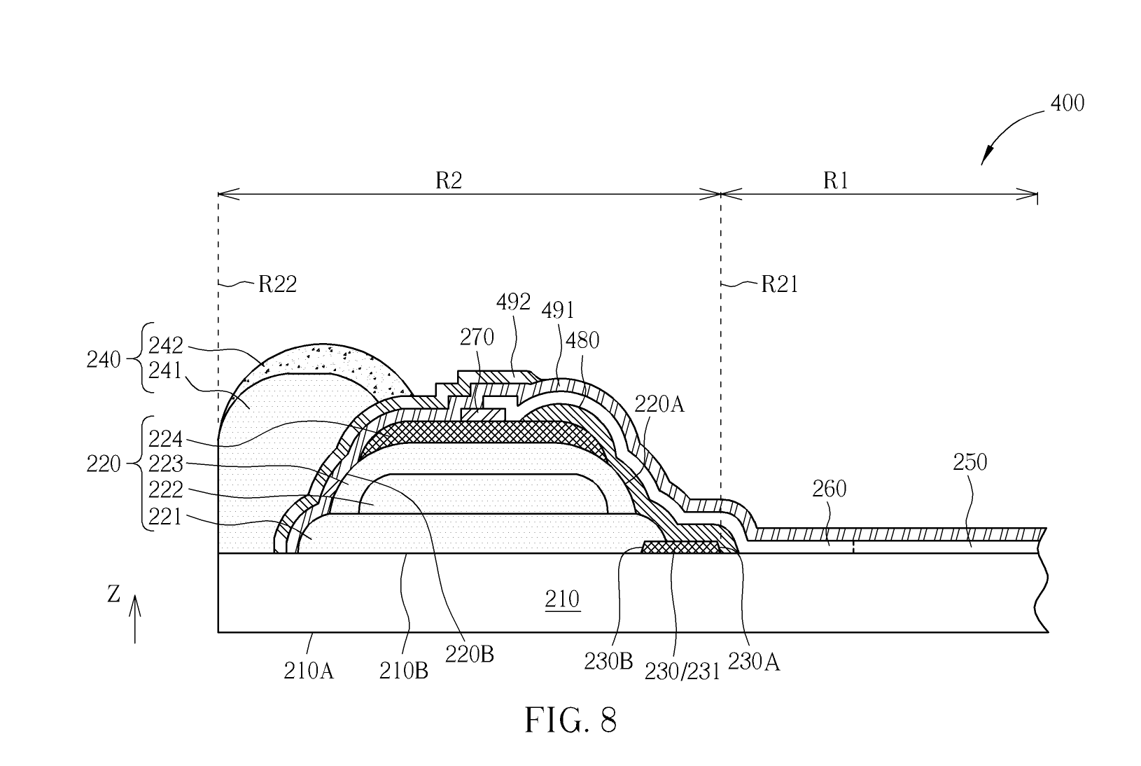

Please refer to FIG. 8. FIG. 8 is a schematic diagram of a touch panel according to the fifth preferred embodiment of the present invention. As shown in FIG. 8, the fifth preferred embodiment of the present invention provides a touch panel 400 that includes a substrate 210, an inner frame 230, and a decoration frame 220. The inner frame 230 and the decoration frame 220 are disposed on the inner surface 210A of the substrate 210 in the peripheral region R2. The inner sidewall 230A of the inner frame 230 is disposed on the inner edge R21 of the peripheral region R2. The decoration frame 220 partially covers the surface of the inner frame 230 and includes the decoration layers 221, 222, 223 and even optionally includes a dark decoration layer 224 disposed on the inner surface 210A in order. The pattern ranges of the decoration layers 221, 222, 223 and the dark decoration layer 224 of the decoration frame 220 are substantially not the same. For example, the pattern range of the decoration layer 221 is greater than the pattern range of the second decoration layer 222 so that the decoration frame 220 can have more smooth inner sidewall 220A. Also, the decoration layer 223 in this embodiment covers the decoration layer 222 to further reduce the horns effect of the edges of the decoration frame 220 in order to avoid the severe topography on the sidewall due to the stacking layers. Therefore, the stacking design of the stacked layers of the decoration frame 220 in this embodiment provides a more gradual climbing angle for the subsequent coated layers.

Moreover, the touch panel 400 of this embodiment includes a planarization layer 480 partially covering the inner frame 230 and the decoration frame 220. The planarization layer 480 wraps and covers the inner sidewall 230A of the inner frame 230 and the inner sidewall 220A of the decoration frame 220 to further make the sidewall surfaces of the layers smoother. Therefore the climbing angle of the connecting part 260 formed subsequently on the planarization layer 480 will be smaller and its coating yield can be improved. Optionally, the inner sidewall of the planarization layer 480 may not cover and wrap the inner sidewall 230A of the inner frame 230, which means that the inner sidewall of the planarization layer 480 may be covered and shielded by the inner frame 230 and not be exposed so as to improve the appearance. The planarization layer 480 may include any suitable insulation materials. The materials of the planarization layer 480 in this embodiment is preferred to be material that may further improve the short circuit caused by the residues of the connecting part 260 on the decoration frame 220. For example, when the connecting part 260 is formed with indium tin oxide and the decoration frame 220 includes ink material, preferably the planarization layer 480 is formed with photoresist. Also, the color of the planarization layer 480 may be transparent or any colors matching the decoration frame 220. Besides, the touch panel 400 may optionally include a light-shielding layer 240. Different from the previous embodiments, the light-shielding layer 240 in this embodiment includes a first light-shielding layer 241 and a second light-shielding layer 242 disposed on the inner surface 210A in order, partially covering the decoration frame 220. Furthermore, it is preferred that the color of the first light-shielding layer 241 is, but not limited to, similar to or the same as the color of the decoration layers 221, 222, 223. In other embodiments, the first light-shielding layer 241 may be designed to have special color as needed to increase the color richness of the peripheral region R2. The second light-shielding layer 242 may be composed of dark materials or materials with higher OD, such as black materials, so as to increase the shielding effect. In this embodiment, the colors and materials of each layer are described in the following as an example. The inner frame 230, the dark decoration layer 224, and the second light-shielding layer 242 are formed with black, gray or other dark-color photoresist or ink materials, and the decoration layers 221, 222, 223 and the first light-shielding layer 241 are formed with white or other color photoresist or ink materials with OD lower than black decoration layers 221, 222, but not limited thereto. The materials and color variety of the touch panel 400 may be referred to the first embodiment of the present invention and not repeated here.

In other embodiment, the decoration layer 223 may further wrap and cover the inner edge of the first decoration layer 221 to partially cover the inner frame 230 and connect with the surface of the inner frame 230 in order to increase the overall thickness of the portion decoration frame 220 near the inner frame 230 for improving the appearance. Moreover, the touch panel 400 may further optionally include an inorganic insulation layer 491 and/or an organic insulation layer 492. The inorganic insulation layer 491 fully covers the decoration frame 220, the wire 270, the connecting part 260, and the touch sensing element 250 to isolate and protect the electronic elements on the surface of the substrate 210 from the exterior. The inorganic insulation layer 491 may be a single-layer film, whose material may be silicon oxide or silicon nitride for example. However, the inorganic insulating layer 491 may be a composite film of silicon oxide and silicon nitride for example. Besides, the inorganic insulation layer 491 may be regarded as an optical layer to provide optical matching functionality and improve the visual effect of the touch panel 400. The organic insulation layer 492 covering a portion of the surface of the inorganic insulation layer 491 is disposed between the inorganic insulation layer 491 and the light-shielding layer 240. Its material, for example, is photoresist, but not limited thereto, or may be silicon oxide to provide protection. In addition, the organic insulation layer 492 may extend toward the light transmission touch sensing region R1 and further fully cover the decoration frame 220, the wire 270, the connecting part 260, and the touch sensing element 250 to provide more complete protection.

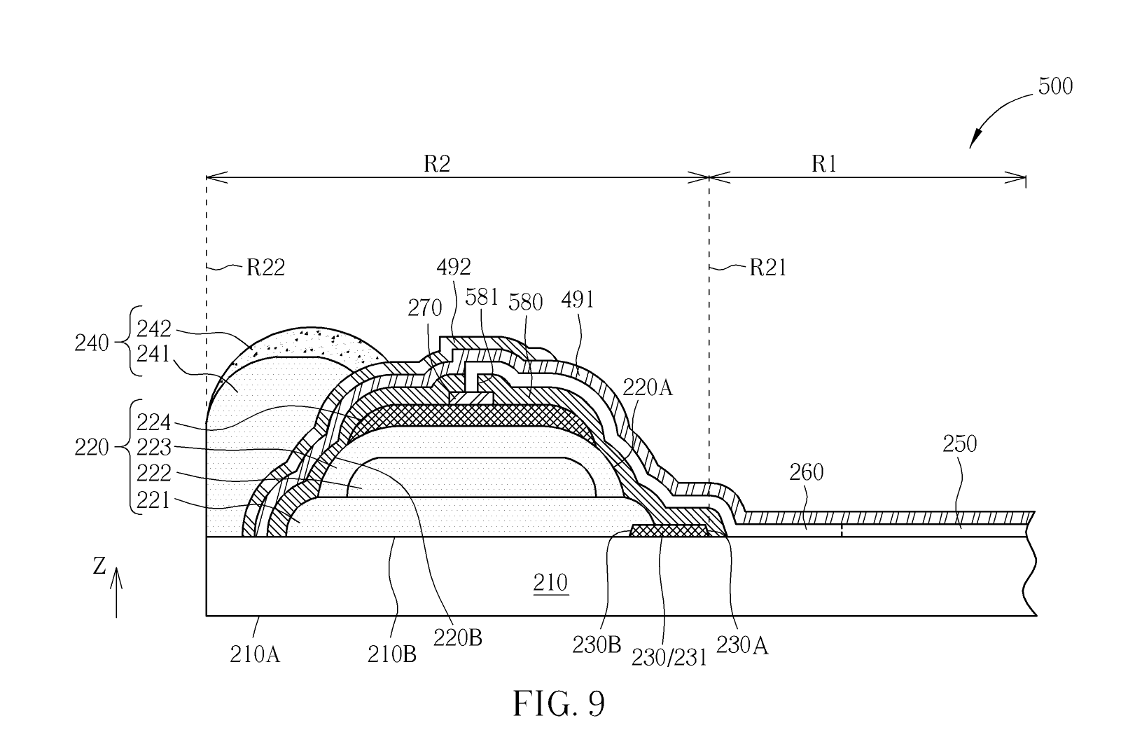

Please refer to FIG. 9. FIG. 9 is a schematic diagram of a touch panel according to the sixth preferred embodiment of the present invention. The difference between this embodiment and the fifth embodiment is that the planarization layer 580 included in the touch panel 500 shown in FIG. 9 wraps and covers the surface of the decoration frame 220, including the inner sidewall 220A and the outer sidewall 220B of the decoration frame 220, to provide better climbing angel for the light-shielding layer 240 and the connecting part 260 formed subsequently, so as to further improve the fabrication quality of the layers. It is noteworthy that the planarization layer 580 includes a contact hole 581. The connecting part 260 fills the contact hole 581 so as to be electrically connected with the wire 270. In other embodiments, the inner sidewall of the planarization layer 580 may not cover and wrap the inner sidewall 230A of the inner frame 230, which means the inner sidewall of the planarization layer 580 may be covered and shielded by the inner frame 230 and not disclosed to improve the appearance.

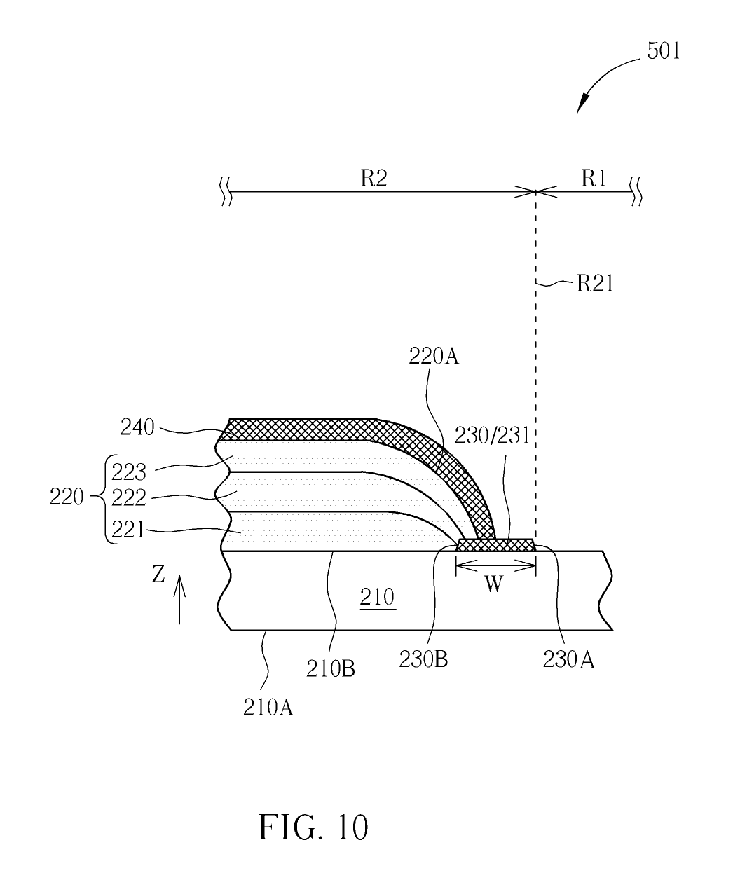

Please refer to FIG. 10. FIG. 10 is a schematic diagram of a touch panel according to the seventh preferred embodiment of the present invention. The decoration frame 220 of the touch panel 501 in this embodiment includes the decoration layers 221, 222, 223 disposed on the inner surface 210B of the substrate 210 in order, wherein the inner edge of the decoration layer 222 wraps the inner edge of the decoration layer 221 and is disposed on the surface of the inner frame 230. In other words, the decoration frame 220 is designed to gradually expand toward the inner edge R21 of the peripheral region R2 from its bottom layer to its top layer, and all of the edges of the decoration layers 221, 222, 223 are covered and shielded by the inner frame 230. For example, the edges of any two of the adjacent decoration layers 221, 222, 223 are separated respectively by about 0.02 to 1 millimeters, and the width W of the inner frame 230 is about 0.04 to 4 millimeters to effectively shield the inner sidewall 220A of the decoration frame 220. Moreover, the light-shielding layer 240 in FIG. 10 covers the inner sidewall 220A of the decoration frame 220 and partially covers the inner frame 230. In other embodiments, the stacking structure of the decoration layers 221, 222, 223 may be contrary to the present embodiment, such as that it retracts gradually from the bottom to the top layer and includes a step-shaped structure, wherein the inner edge of the decoration layer 222 is closer to the inner edge R21 of the peripheral region R2 than the decoration layer 223, and the inner edge of the decoration layer 221 is closer to the inner edge R21 of the peripheral region R2 than the decoration layer 222. This design can increase the climbing performance of the conductive elements fabricated in the subsequent process. The touch panel 501 of this embodiment may optionally include wire(s), connecting part(s), touch sensing element(s), light-shielding layer(s), and planarization layer(s) not shown in FIG. 10, wherein their disposition positions, materials, and fabrication methods can be referred to the embodiments mentioned above and will not be repeated.

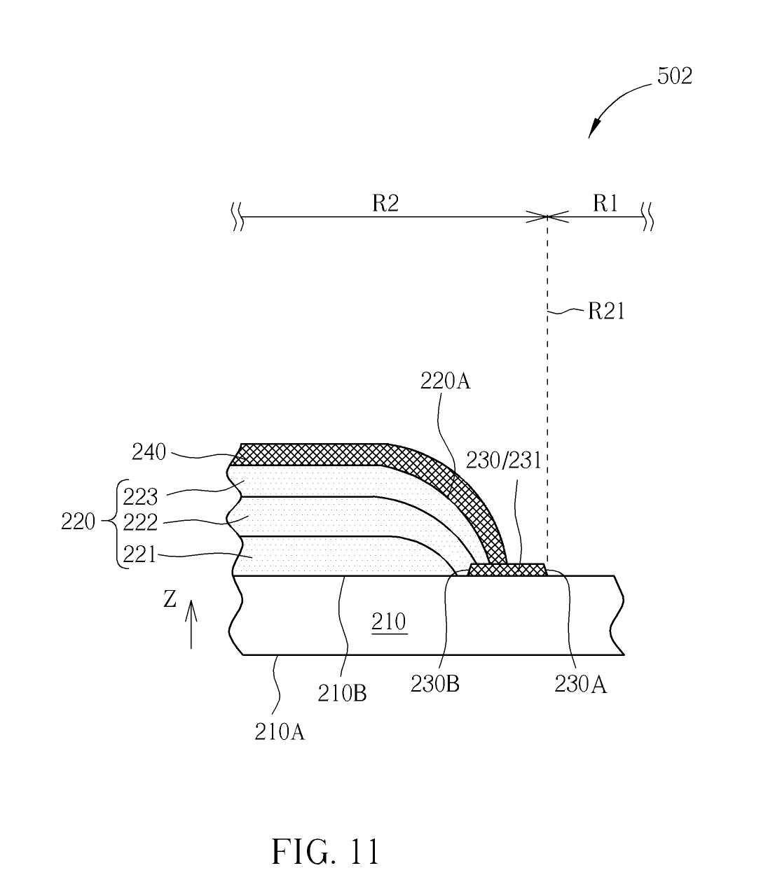

Please refer to FIG. 11. FIG. 11 is a schematic diagram of a touch panel according to the eighth preferred embodiment of the present invention. The difference between the touch panel 502 of this embodiment and the seventh preferred embodiment is that when the deviation occurs in the formation of the decoration layer 221, the first decoration layer 221 may not partially cover the inner frame 230, which means the decoration layer 221 does not overlap the inner frame 230 in the vertical projection direction Z. In this situation, since the inner frame 230 still covers and shields the inner sidewall 220A of the decoration frame 220, with that the decoration layers 222 and 223 are still stacked on the surface of the inner frame 230, and the color contrast of the inner frame 230 and the decoration layer 221 is great enough, the inner edge of the decoration layer 221 and any zigzag of the inner edges of the stacked layers of the decoration frame 220 will not be seen clearly. Therefore, the appearance problems caused by production tolerances will be improved. The touch panel 502 in this embodiment may optionally include wire(s), connecting part(s), touch sensing element(s), light-shielding layer(s), and planarization layer(s) not shown in FIG. 11. Their disposition positions, materials, and fabrication methods may be referred to the embodiments mentioned above and will not be repeated here.

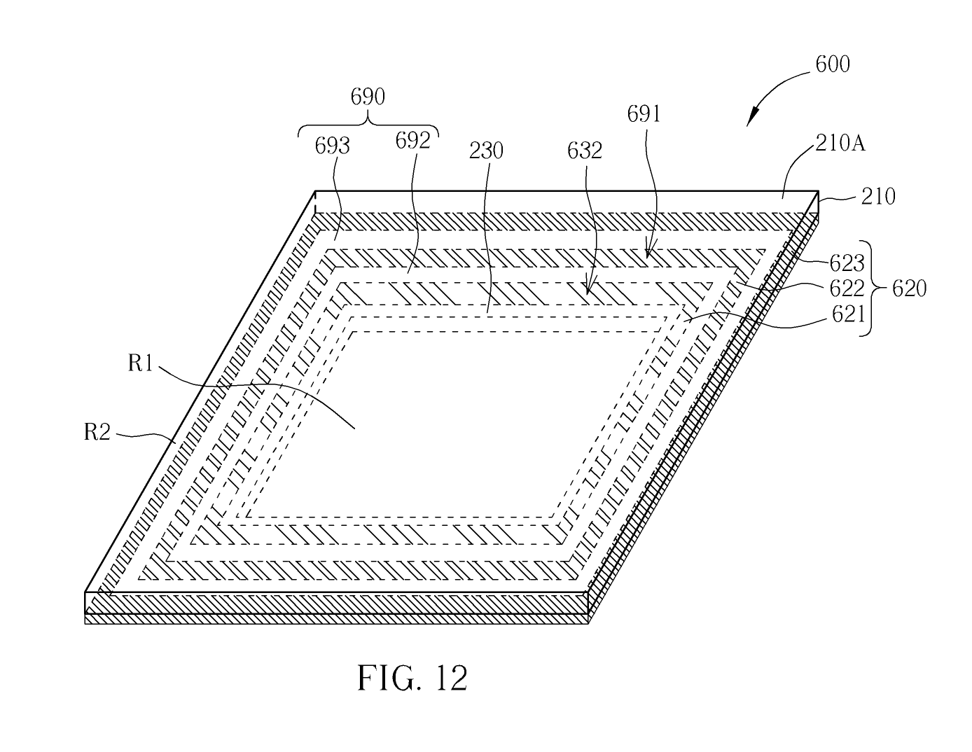

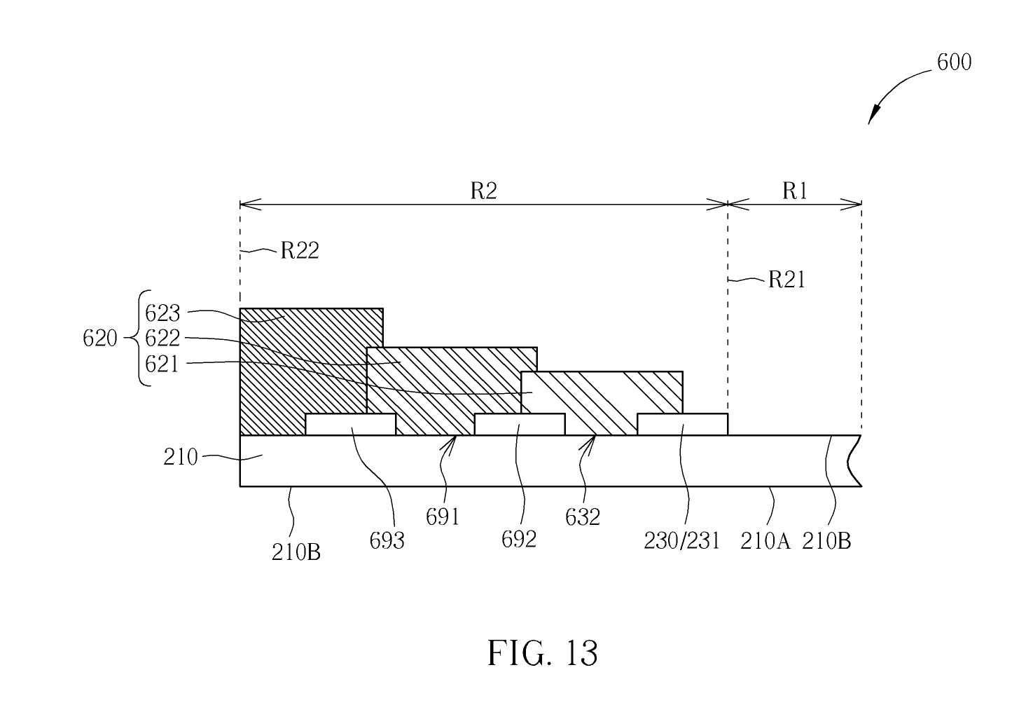

Please refer to FIG. 12 and FIG. 13. FIG. 12 is a schematic diagram of the top view of a touch panel according to the ninth preferred embodiment of the present invention. FIG. 13 is a schematic diagram of the partial cross-sectional view of the touch panel shown in FIG. 12. The difference between this embodiment and the first embodiment is that the decoration frame 620 of the touch panel 600 of the present invention includes a first decoration layer 621, a second decoration layer 622, and a third decoration layer 623 orderly disposed from the inner side to the outer side of the peripheral region R2 in order, as shown in FIG. 12 and FIG. 13. In other words, the second decoration layer 622 is disposed at the outer side of the first decoration layer 621, and it is disposed between the first decoration layer 621 and the third decoration layer 623. In a preferred embodiment, the colors of the first decoration layer 621, the second decoration layer 622, and the third decoration layer are different from each other, but not limited thereto. The touch panel 600 further includes an outer frame 690 disposed on the inner surface 210B of the substrate 210, at the outer side of the inner frame 230 and between the substrate 210 and the decoration layers 621, 622, 623, which means the decoration layers 621, 622, 623 are disposed on top of the outer frame 690. The outer frame 690 includes a first outer frame layer 692 and a second outer frame layer 693. There is a gap 632 disposed between the outer frame 690 and the inner frame 230, and a gap 691 is disposed between the first outer frame layer 692 and the second outer frame layer 693. In this embodiment, the gaps 632 and 691 are frame-shaped patterns with uniform width respectively. At least a portion of the first decoration layer 621 is disposed in the gap 632 and disposed between the inner frame 230 and the first outer frame layer 692. At least a portion of the second decoration layer 622 is disposed in the gap 691 and disposed between the first outer frame layer 692 and the second outer frame layer 693. At least a portion of the decoration layer 623 is disposed at the outer side of the outer frame 690 and disposed along the outer edge R22 of the peripheral region R2. Therefore, when viewing the touch panel 600 from the side of the touch surface 210A of the substrate 210, the first, second, and third decoration layers 621, 622, 623 with different colors are shown respectively through the gap 632, the gap 691 and the outer side of the outer frame 690, so as to increase the appearance variety of the touch panel 600 and improve its appearance. It is noteworthy that the thickness of each layer of the decoration frame 620 in FIG. 13, for example, is as following. The thickness of the third decoration layer 623 is greater than the second decoration layer 622, and the thickness of the second decoration layer 622 is greater than the first decoration layer 621. In addition, the inner edge of the third decoration layer 623 partially covers the second decoration layer 622, and the inner edge of the second decoration layer 622 partially covers the first decoration layer 621. However, the present invention is not limited to the above-mentioned thickness design. In other embodiment, the first, second, and third decoration layers 621, 622, 623 may have the same thickness and do not cover each other. The touch panel 600 of this embodiment may optionally include wire(s), connecting part(s), touch sensing element(s), light-shielding layer(s), and planarization layer(s) not shown in FIG. 12 and FIG. 13. Their disposition positions, materials, and fabrication methods may be referred to the embodiments mentioned above and will not be repeated herein. It is noteworthy that the outer frame 690 in this embodiment may also be regarded as only having one single outer frame layer with the opening pattern as the gap 691 to expose the second decoration layer 622. In addition, in a preferred embodiment, the first outer frame layer 692, the second outer frame layer 693, and the inner frame 231 include the same material, OD, and thickness and may be fabricated with the same method, such as fabricated by a lithography process or a screen printing process.

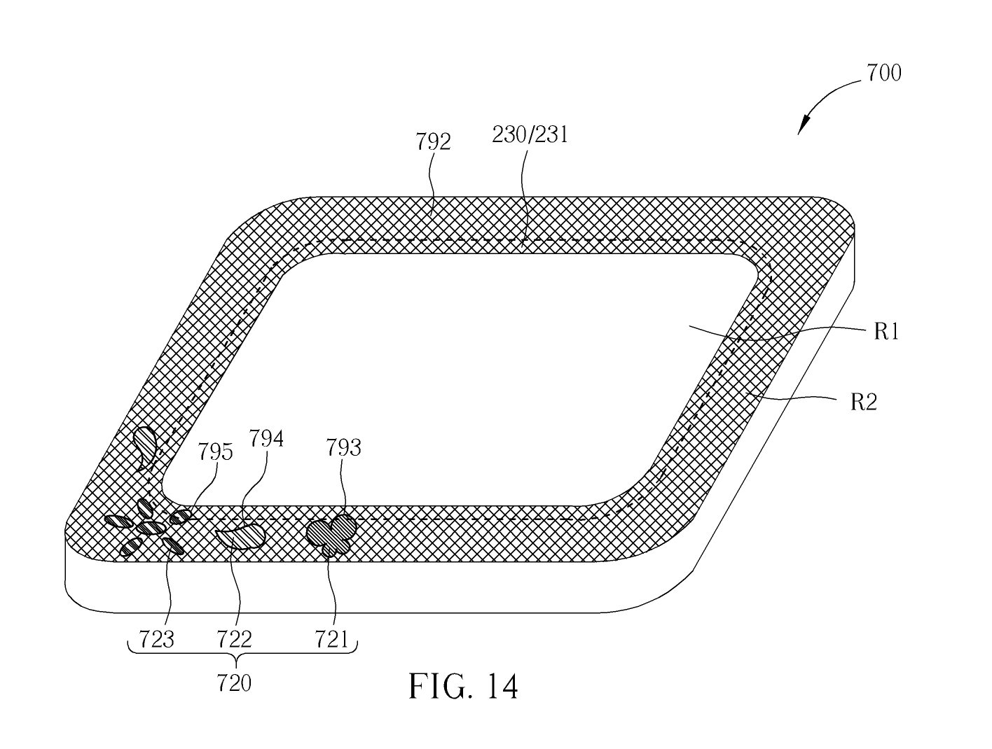

Please refer to FIG. 14. FIG. 14 is a schematic diagram of the exterior of a touch panel according to the tenth preferred embodiment of the present invention. As shown in FIG. 14, the touch panel 700 includes an inner frame 230 and an outer frame 792 disposed on the inner surface of the substrate not illustrated. Wherein the outer frame 792 disposed at the outer side of the inner frame 230 includes a first pattern opening 793, a second pattern opening 794, and a third pattern opening 795. The touch panel 700 includes a decoration frame 720 including a first decoration layer 721, a second decoration layer 722, and a third decoration layer 723. At least a portion of the first decoration layer 721, the second decoration layer 722, and the third decoration layer 723 are disposed respectively in the first pattern opening 793, the second pattern opening 794, and the third pattern opening 795. Therefore, when viewing the touch panel 700 from the outer side, the first pattern opening 793, the second pattern opening 794, and the third pattern opening 795 respectively expose the first decoration layer 721, the second decoration layer 722, and the third decoration layer 723. According to this embodiment, the first, second, and the third pattern openings 793, 794, 795 may be designed to have special patterns, such as decorative patterns and the function icons of the touch-control cellular phones, wherein the function icon pattern may be words including letters, logos, numbers and so on, or be symbols such as icon symbols, geometry, holes, and so on. With the design of the first, second, and third decoration layers 721, 722, 723 with mutually different colors, the exterior surface of the touch panel 700 will have appearance with rich colors and various patterns. In a preferred embodiment, the inner frame 230 and the outer frame 792 are disposed closely adjacent to each other and may have the same color, such as dark color or black. The inner frame 230 and the outer frame 792 are fabricated simultaneously with the same material and by the same fabrication process. In another embodiment, the inner frame 230 may optionally include a pattern opening and a decoration layer disposed within. The touch panel 700 of this embodiment may operationally include wire(s), connecting part(s), touch sensing element(s), light-shielding layer(s), and planarization layer(s) not shown in FIG. 14. The disposition positions, materials, and fabrication methods of the above-mentioned elements and the inner frame 230, the outer frame 792, and the substrate may be referred to the embodiments mentioned above and will not be repeated herein.

Since the touch panel of the present invention is designed to include an inner frame, it has the following advantages. First, the inner edge of the peripheral region has an even frame-shaped pattern. Second, it improves the problems of low light-shielding or uneven light permeability of the edges of the decoration frame on the surface of the traditional touch panel. Third, the inner frame can solve the problems of poor quality or uneven edges of the decoration layers caused by the printing tolerance of the multiple decoration layers. Fourth, the inner frame can shield the bubbles caused by the subsequent process of attaching the substrate onto the display panel. Fifth, since the inner frame can serve as the first climbing step of the subsequently coated film, the climbing condition is improved, such that the subsequently formed decoration layers can share the same printing screen without extraordinarily designed gentle slope in the prior art. Therefore, the fabrication process and the design costs are reduced. Moreover, some embodiments of the present invention disclose a design of dark inner frame with dark outer frame that may have pattern openings with good appearance and diversity, which can be filled with subsequently formed decoration layers with various colors individually, so as to replace the monotonous design of the decoration frame according to the prior art. In addition, the planarization layer disposed on the surface of the inner frame and the decoration frame can improve the climbing performance of the subsequently formed conductive material in order to improve the product reliability. Therefore, the present invention provides a touch panel with good appearance, low fabrication cost and high reliability.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel having a light transmission touch sensing region and a peripheral region disposed on at least one side of the transparent touch sensing region, wherein the peripheral region having an inner edge and an outer edge and the inner edge is closer to the light transmission touch sensing region than the outer edge, the touch panel comprising:
an inner frame, disposed in the peripheral region and comprising at least an inner frame layer, wherein an inner sidewall of the inner frame is disposed along the inner edge of the peripheral region; and
a decoration frame, disposed in the peripheral region, wherein the decoration frame includes at least one decoration layer, and the pattern range of the decoration layer does not exceed the inner edge of the peripheral region.

2. The touch panel of claim 1, wherein the pattern range of the inner frame is smaller than an area of the peripheral region, and the decoration frame covers a portion of the inner frame.

3. The touch panel of claim 2, wherein an optical density (OD) of the inner frame layer is greater than an OD of the decoration layer.

4. The touch panel of claim 2, wherein a material of the inner frame layer comprises photoresist.

5. The touch panel of claim 4, wherein a material of the decoration layer comprises ink.

6. The touch panel of claim 5, wherein the inner frame layer has the same color as the decoration layer.

7. The touch panel of claim 2, further comprising a substrate, wherein the decoration layer further comprises a first decoration layer and a second decoration layer disposed on the substrate in order, and a pattern range of the first decoration layer is substantially equal to a pattern range of the second decoration layer.

8. The touch panel of claim 2, further comprising a substrate, wherein the decoration layer comprises a first decoration layer and a second decoration layer disposed on the substrate in order, and a pattern range of the first decoration layer is greater than a pattern range of the second decoration layer.

9. The touch panel of claim 2, further comprising a light-shielding layer disposed on a surface of the decoration frame, wherein the light-shielding layer partially covers a surface of the inner frame.

10. The touch panel of claim 2, wherein the decoration frame comprises a dark decoration layer disposed on the decoration layer, and the dark decoration layer partially covers a surface of the inner frame.

11. The touch panel of claim 2, wherein the decoration frame comprises a dark decoration layer disposed on the decoration layer, and an inner sidewall of the dark decoration layer partially overlaps the inner frame in the vertical projection direction.

12. The touch panel of claim 2, further comprising a planarization layer covering the inner sidewall of the inner frame and an inner sidewall of the decoration frame.

13. The touch panel of claim 12, wherein the planarization layer further covers an outer sidewall of the decoration frame.

14. The touch panel of claim 2, further comprising a light-shielding layer disposed on a surface of the decoration frame, and an inner sidewall of the light-shielding layer partially overlaps the inner frame in the vertical projection direction.

15. The touch panel of claim 14, wherein the overall pattern range of both the inner frame and the light-shielding layer is substantially the same as the area of the peripheral region.

16. The touch panel of claim 2, further comprising a substrate and an outer frame disposed on the substrate, the outer frame being disposed at an outer side of the inner frame and between the substrate and the decoration layer, and the outer frame comprising at least one outer frame layer, wherein the outer frame layer and the inner frame layer have the same materials, the same OD, and the same thickness.

17. The touch panel of claim 16, wherein the outer frame comprises at least one opening and at least one portion of the decoration layer disposed on the outer frame is disposed in the opening.

18. The touch panel of claim 17, wherein the decoration frame comprises a first decoration layer and a second decoration layer, the first decoration layer and the second decoration layer have different colors, the opening of the outer frame comprises a first opening and a second opening, and at least one portion of the first decoration layer and at least one portion of the second decoration layer are disposed respectively in the first opening and the second opening.

19. The touch panel of claim 16, wherein the outer frame comprises a first outer frame layer, and the decoration frame comprises a first decoration layer and a second decoration layer with different colors, at least one portion of the first decoration layer is disposed between the inner frame and the first outer frame layer, and at least one portion of the second decoration layer is disposed at an outer side of the outer frame layer.

20. The touch panel of claim 2, further comprising:
a substrate;
a touch sensing element, disposed on the substrate in the light transmission touch sensing region;
a wire, disposed on the decoration frame in the peripheral region; and
a connecting part, electrically connected to the touch sensing element and extending along a sidewall of the decoration frame to be electrically connected to the wire.

21. The touch panel of claim 20, wherein the connecting part is a part of the touch sensing element.

22. The touch panel of claim 21, further comprising an optical layer disposed between both the inner frame and the decoration frame and the substrate.

23. The touch panel of claim 22, wherein the optical layer comprises at least one of silicon oxide, silicon nitride or titanium oxide.

24. The touch panel of claim 22, wherein the optical layer comprises at least one of acrylic resin, epoxy resin, phenolic resin, siloxane or polyimide.

25. The touch panel of claim 2, further comprising a substrate carrying the inner frame and the decoration frame and another substrate carrying a touch sensing element.

26. The touch panel of claim 25, wherein the substrate carrying the touch sensing element is a glass substrate, a film substrate, a color filter substrate of a LCD or an encapsulation plate of an OLED display.

27. The touch panel of claim 20, wherein the touch sensing element comprises a plurality of first axial electrodes and a plurality of second axial electrodes isolated from each other, and the first axial electrodes and the second axial electrodes cross to each other.

28. The touch panel of claim 20, wherein the touch sensing element comprises a plurality of inducing electrodes disposed separated from each other.

29. A touch panel, comprising a light transmission touch sensing region and a peripheral region disposed on at least one side of the light transmission touch sensing region, the touch panel comprising:
a decoration frame, disposed in the peripheral region and having an inner sidewall and an outer sidewall opposite to each other, the inner sidewall being adjacent to the light transmission touch sensing region; and
an inner frame, disposed in the peripheral region and covering at least one portion of the inner sidewall of the decoration frame, the inner frame exposing the outer sidewall of the decoration frame.

30. The touch panel of claim 29, wherein the inner frame comprises an inner sidewall and an outer sidewall opposite to each other, the inner sidewall of the decoration frame does not exceed the inner sidewall of the inner frame, and the outer sidewall of the decoration frame exceeds the outside wall of the inner frame.

31. The touch panel of claim 29, wherein the inner frame comprises at least one inner frame layer, the decoration frame comprises at least one decoration layer, and an optical density (OD) of the inner frame layer is higher than an OD of the decoration layer.

32. The touch panel of claim 29, wherein a material of the inner frame comprises photoresist.
